(19) United States
(12) Patent Application Publication
(10) Pub. No.: US 2005/0190827 A1
(43) Pub. Date: Sep. 1, 2005

(54) Modulation/demodulation apparatus for the encoding and decoding of data and method for encoding and decoding data

(76) Inventors: Chang Qing Xu, Singapore (SG); Masayuki Tomisawa, Singapore (SG)

Correspondence Address: OSTROLENK FABER GERB & SOFFEN, 1180 AVENUE OF THE AMERICAS, NEW YORK, NY, 100368403, US

(21) Appl. No.: 11/065,827

(22) Filed: Feb. 25, 2005

(30) Foreign Application Priority Data
Feb. 26, 2004 (SG) 200401044-3

(51) Int. Cl. H04B 1/38

(52) U.S. Cl. 375/222

(57) ABSTRACT

A modulation/demodulation apparatus for the encoding and decoding of data, for example in a Bluetooth/WLAN/PHS multi-mode system based on software defined radio comprises an encoding system to encode data according to a plurality of modulation schemes and a decoding system to decode according to the plurality of modulation schemes the encoded data from the encoding system. The encoding system comprises a number of encoding look-up tables which include encoding data for encoding data according to the plurality of modulation schemes, the encoding data for a plurality of the modulation schemes being identical. Similarly, the decoding system comprises a number of decoding look-up tables for decoding the encoded data received from the encoding system. The decoding look-up tables comprise decoding data for decoding data according to the plurality of modulation schemes, the decoding data for a plurality of the modulation schemes being identical. Also disclosed is a method for encoding/decoding data.

### FIELD OF THE INVENTION

The present invention relates to a modulation/demodulation apparatus for the encoding and decoding of data and a method for encoding and decoding data. In particular, the invention relates to modulation/demodulation apparatus and methods for use in Bluetooth/WLAN/PHS multi-mode systems, based on software defined radio.

### BACKGROUND OF THE INVENTION

In multi-mode systems in which information is exchanged wirelessly, there is a requirement to achieve seamless performance, that is, to harmonise different wireless communication systems. This process is known as ubiquitous networking. To achieve this ubiquitous networking, protocol roaming among different wireless systems, such as personal network systems (Bluetooth), hot spot network systems (WLAN) and cellular network systems (GSM/WCDMA/PHS) will be necessary.

The specification for medium rate Bluetooth systems is described in Bluetooth Medium Rate Specifications, V 0.7, Bluetooth SIG, April 2003 and the specification for WLAN systems is described in Wireless LAN Medium Access Control (MAC) and physical layer (PHY) specifications, IEEE Standard 802.11, 1999. The specification for cellular network systems is described in Personal Handy Phone System, RCR STD-28, Ver. 1, Rev. 1, 1995.

To achieve protocol roaming, a number of modulation/demodulation schemes must be supported and hence there is a need for a general modulation/demodulation scheme which is cost effective to use and produce and which is not complex.

In conventional multi-mode systems based on Software Defined Radio (SDR), which uses reconfigurable architecture, many particular processing algorithms are employed to process different modulation schemes and each modulation scheme has a corresponding dedicated modulation/demodulation algorithm. As a result, these systems have a large memory requirement and are very complex.

Thus, to design a commercially viable SDR system having protocol roaming, a number of problems need to be solved, in particular, a general modulation/demodulation system is required.

### SUMMARY OF THE INVENTION

In general terms, the present invention comprises a method and apparatus for encoding and decoding data using one or more look-up tables to speed and simplify the encoding/decoding process. The systems and methods embodying the present invention have a high performance and a low complexity and they are also flexible. Furthermore, one or more preferred embodiments of the invention enable the building of network and handheld terminals that support multi-standard, multi-band, multi-mode, multi-function, and multi-service systems, thereby enabling the end user to enjoy seamless, ubiquitous personal communication services.

According to a first aspect of the invention there is provided a modulation/demodulation apparatus for the encoding and decoding of data, said apparatus comprising: an encoding system to encode incoming data according to a first plurality of modulation schemes; and a decoding system to decode according to said first plurality of modulation schemes said encoded data from said encoding system; wherein the encoding system comprises one or more encoding look-up tables, said one or more encoding look-up tables comprising encoding data for encoding said incoming data according to said first plurality of modulation schemes, wherein said encoding data for a number of said first plurality of modulation schemes is identical; and wherein the decoding system comprises one or more decoding look-up tables for decoding said encoded data received from said encoding system, said one or more decoding look-up tables comprising decoding data for decoding data according to said first plurality of modulation schemes, wherein said decoding data for a number of said first plurality of modulation schemes is identical.

In one embodiment, said encoding system comprises: a converter for converting incoming data to one or more binary words, said binary words being formed of one or more information bits; and a selector for selecting a type of modulation to be applied to said one or more binary words; wherein said one or more encoding look-up tables are arranged for determining one or more modulation angles corresponding to said one or more information bits according to said selected type of modulation; said encoding system further comprising a first processor for determining an in-phase value and a quadrature value for said one or more modulation angles for transmission to said decoding system.

In that embodiment, the modulation/demodulation apparatus may comprise: a second processor for determining said one or more modulation angles from said in-phase and quadrature values received from said encoding system; and a selector for determining the type of modulation applied to said encoded signal; wherein said one or more decoding look-up tables are arranged to determine said one or more binary words formed by said encoding system, said decoding system further comprising a converter for converting said one or more binary words into a data output signal.

The encoding system may be a software implemented system. The decoding system may be a software implemented system.

One or more of the encoding look-up tables may be implemented in a hardware system. One or more of the decoding look-up tables may be implemented in a hardware system.

Said first-processor may be implemented in a hardware system. Said second processor may be implemented in a hardware system.

Said first processor may be implemented in a software system. Said second processor may be implemented in a software system.

The encoding data may be comprised of data from mapping tables associated with said plurality of modulation schemes. In that case, the data from said mapping tables may comprise a combination of data from similar modulation schemes so that similar modulation schemes use the same encoding data.

The decoding data may be comprised of data from mapping tables associated with said plurality of modulation schemes. In that case, the data from said mapping tables may comprise a combination of data from similar modulation schemes so that similar modulation schemes use the same decoding data.

The plurality of modulation schemes may comprise multi-array phase shift keying (MPSK) and multi-array differential phase shift keying (MDPSK).

The plurality of modulation schemes may comprise a combination of any two or more of BPSK, QPSK, QPSK-CCK, DBPSK,DQPSK, DQPSK-CCK,pi/4-DQPSK, and 8DPSK.

The first processor may be arranged to determine said in-phase and quadrature values using trigonometric functions. The first processor may be arranged to determine said in-phase and quadrature values using a look-up table.

The second processor may be arranged to determine said one or more modulation angles from said in-phase and quadrature values by calculating the inverse tangent of the angle represented by said in-phase and quadrature values.

According to a second aspect of the invention there is provided a Bluetooth system comprising the modulation/demodulation apparatus defined above.

According to a third aspect of the invention there is provided a WLAN system comprising the modulation/demodulation apparatus defined above.

According to a fourth aspect of the invention there is provided a cellular network system comprising the modulation/demodulation apparatus defined above.

According to a fifth aspect of the invention there is provided a multi-mode system based on a software defined radio system comprising the modulation/demodulation apparatus defined above.

According to a sixth aspect of the invention there is provided a method for encoding and decoding data, said method comprising: encoding data according to a first plurality of modulation schemes; and decoding according to said first plurality of modulation schemes said encoded data; wherein the step of encoding data comprises applying identical encoding data from one or more encoding look-up tables to data to be encoded according to a number of said first plurality of modulation schemes; and wherein the step of decoding data comprises applying identical decoding data from one or more decoding look-up tables to data to be decoded according to a number of said first plurality of modulation schemes.

The step of encoding may comprise, in an encoding system, the steps of: converting incoming data to one or more binary words, said binary words being formed of one or more information bits; selecting a type of modulation to be applied to said one or more binary words; determining using said one or more encoding look-up tables one or more modulation angles corresponding to said one or more information bits according to said selected type of modulation; and determining an in-phase value and a quadrature value for each of a number of said one or more modulation angles for transmission to a decoding system.

The step of decoding may comprise: determining said one or more modulation angles from said in-phase and quadrature values received from said encoding system; determining the type of modulation applied to said encoded signal; determining using said one or more decoding look-up tables said one or more binary words formed by said encoding system; and converting said one or more binary words into a data output signal.

The step of encoding may be implemented in a software system. The step of decoding may be implemented in a software system.

The step of applying identical encoding data from one or more encoding look-up tables may be implemented in a hardware system. The step of applying identical decoding data from one or more decoding look-up tables may be implemented in a hardware system.

The step of determining an in-phase value and a quadrature value may be implemented in a hardware system. The step of determining said one or more modulation angles may be implemented in a hardware system.

The step of determining an in-phase value and a quadrature value may be implemented in a software system. The step of determining said one or more modulation angles may be implemented in a software system.

The step of applying identical encoding data may comprise applying data from mapping tables associated with said plurality of modulation schemes.

The step of applying data from mapping tables may comprise applying a combination of data from similar modulation schemes so that similar modulation schemes use the same encoding data.

The step of applying identical decoding data may comprise applying data from mapping tables associated with said plurality of modulation schemes.

The step of applying data from mapping tables may comprise applying a combination of data from similar modulation schemes so that similar modulation schemes use the same decoding data.

The step of encoding may comprise encoding said data according to multi-array phase shift keying (MPSK) and multi-array differential phase shift keying (MDPSK) modulation schemes.

The step of encoding may comprise encoding said data according to a combination of any two or more of BPSK, QPSK, QPSK-CCK, DBPSK,DQPSK, DQPSK-CCK,pi/4-DQPSK, and 8DPSK modulation schemes.

The step of determining said in-phase and quadrature values may comprise determining said values using trigonometric functions. The step of determining said in-phase and quadrature values may comprise determining said values using a look-up table.

The step of determining said one or more modulation angles from said in-phase and quadrature values may comprise calculating the inverse tangent of the angle represented by said in-phase and quadrature values.

According to a seventh aspect of the invention there is provided a method for encoding and decoding data in a Bluetooth system comprising the method defined above.

According to a eighth aspect of the invention there is provided a method for encoding and decoding data in a WLAN system comprising the method defined above.

According to a ninth aspect of the invention there is provided a method for encoding and decoding data in a cellular network system comprising the method defined above.

According to a tenth aspect of the invention there is provided a method for encoding and decoding data in a multi-mode system based on a software defined radio system comprising the method defined above.

### BRIEF DESCRIPTION OF THE DRAWINGS

The present invention will now be described by way of example and with reference to the accompanying drawings in which:

FIG. 1 is a flow diagram of a general modem for use in an SDR system according to an embodiment of the invention; and

FIG. 2 is a graph showing the variation of theoretical BER values and simulated results against the signal-to-noise ratio (SNR) of a general modem according to an embodiment of the invention for use with MPSK/MDPSK modulation schemes.

### DESCRIPTION OF PREFERRED EMBODIMENTS

In a first preferred embodiment, a Bluetooth/WLAN/PHS multi-mode system based on SDR is considered. Multi-array phase shift keying (MPSK) and multi-array differential phase shift keying (MDPSK) are the major modulation schemes employed in these systems and there are a number of possible variations of each modulation scheme suitable for use in Bluetooth/WLAN/PHS multi-mode systems. Table 1 lists the main modulation schemes for Bluetooth, WLAN and PHS and examples of possible variations of each modulation scheme.

TABLE 1
MPSK/MDPSK for Bluetooth/WLAN/PHS

| | |
|---|---|
| MPSK | BPSK, QPSK, QPSK-CCK |
| MDPSK | DBPSK, DQPSK, DQPSK-CCK, pi/4-DQPSK, 8DPSK |

The types of modulation schemes used in Bluetooth/WLAN/PHS systems and their operating modes are set out in Table 2.

TABLE 2
Modulation Schemes and Operation Modes

| Operation Modes | | Modulation Schemes | Data Rate | |
|---|---|---|---|---|
| Bluetooth MR | | Pi/4-DQPSK | 2 | Mbps |
| | | 8DPSK | 3 | Mbps |
| WLAN | ERP- | DBPSK | 1 | Mbps |
| | DSSS | DQPSK | 2 | Mbps |
| | ERP-CCK | DQPSK-CCK | 5.5 | Mbps |
| | | DQPSK-CCK + QPSK- | 11 | Mbps |
| | | CCK | | |
| | ERP-OFDM | BPSK | 6/9 | Mbps |
| | DSSS- | QPSK | 12/18 | Mbps |
| | OFDM | | | |

| | | | |
|---|---|---|---|
| PHS | Pi/4-DQPSK | 32 | kbps |

The encoding/decoding mapping tables of MPSK/MDPSK for Bluetooth/WLAN/PHS systems are presented as follows. Tables 3 to 10 below map the phase shift-corresponding to various information bits in the modulation systems listed in Table 2 and the demodulation threshold relating to each of the information bits.

TABLE 3
Mapping Tables for DBPSK-DSSS 1 Mbps

| Modulation | Information Bits | Phase Shift |
|---|---|---|
| | 0 | 0 |
| | 1 | π |
| Demodulation | Threshold | Information Bits |
| | <π/2 or >3* π/2 | 0 |
| | Else | 1 |

TABLE 4
Mapping Tables for DQPSK-DSSS 2 Mbps

| Modulation | Information Bits | Phase Shift |
|---|---|---|
| | 00 | 0 |
| | 01 | π/2 |
| | 11 | π |
| | 10 | −π/2 |
| Demodulation | Threshold | Information Bits |
| | <π/4 or >7* π/4 | 00 |
| | <3* π/4 | 01 |
| | <5* π/4 | 11 |
| | Else | 10 |

TABLE 5
Mapping Tables for DQPSK-CCK

| Modulation | Information Bits | Phase Shift |
|---|---|---|
| | 00 | π |
| | 01 | −π/2 |
| | 11 | 0 |
| | 10 | π/2 |
| Demodulation | Threshold | Information Bits |
| | <π/4 or >7* π/4 | 11 |
| | <3* π/4 | 10 |
| | <5* π/4 | 00 |
| | Else | 01 |

TABLE 6
Mapping Tables for Pi/4 DQPSK-Bluetooth MR

| Modulation | Information Bits | Phase Shift |
|---|---|---|
| | 00 | π/4 |
| | 01 | 3* π/4 |
| | 11 | −3* π/4 |
| | 10 | −π/4 |
| Demodulation | Threshold | Information Bits |
| | <π/2 | 00 |
| | <π | 01 |
| | <3* π/2 | 11 |
| | Else | 10 |

TABLE 7
Mapping Tables for 8DPSK-Bluetooth MR

| Modulation | Information Bits | Phase Shift |
|---|---|---|
| | 000 | 0 |
| | 001 | π/4 |
| | 011 | π/2 |
| | 010 | 3* π/4 |
| | 110 | π |
| | 111 | −3* π/4 |
| | 101 | −π/2 |
| | 100 | −π/4 |
| Demodulation | Threshold | Information Bits |
| | <π/8 or >15* π/8 | 000 |
| | <3* π/8 | 001 |
| | <5* π/8 | 011 |
| | <7* π/8 | 010 |
| | <9* π/8 | 110 |
| | <11* π/8 | 111 |
| | <13* π/8 | 101 |
| | Else | 100 |

TABLE 8
Mapping Tables for BPSK-OFDM

| Modulation | Information Bits | Phase |
|---|---|---|
| | 0 | π |
| | 1 | 0 |
| Demodulation | Threshold | Information Bits |
| | <π/2 or >3* π/2 | 1 |
| | Else | 0 |

TABLE 9
Mapping Tables for QPSK-OFDM

| Modulation | Information Bits | Phase |
|---|---|---|
| | 00 | −3* π/4 |
| | 01 | 3* π/4 |
| | 11 | π/4 |
| | 10 | −π/4 |
| Demodulation | Threshold | Information Bits |
| | <π/2 | 11 |
| | <π | 01 |
| | <3* π/2 | 00 |
| | Else | 10 |

TABLE 10
Mapping Tables for QPSK-CCK

| Modulation | Information Bits | Phase Shift |
|---|---|---|
| | 00 | 0 |
| | 01 | π/2 |
| | 11 | −π/2 |
| | 10 | π |
| Demodulation | Threshold | Information Bits |
| | <π/4 or >7* π/4 | 00 |
| | <3* π/4 | 01 |
| | <5* π/4 | 10 |
| | Else | 11 |

From a consideration of the above Tables 3 to 10, the Applicant has appreciated that it is possible to combine a number of the aforementioned mapping tables to produce look-up tables for use in encoding and decoding. For example, BPSK-OFDM and DBPSK-DSSS may share a look-up table. Similarly, DQPSK-DSSS, QPSK-CCK and DQPSK-CCK may share a look-up table. Furthermore, pi/4-DQPSK and QPSK-OFDM may share a look-up table.

Once the look up tables have been combined, it is possible to define the connections between the modulation schemes and the look-up tables. Using the combined look-up tables and corresponding control systems, it is possible to produce a general modem, for example, for both MPSK and MDPSK modulation schemes.

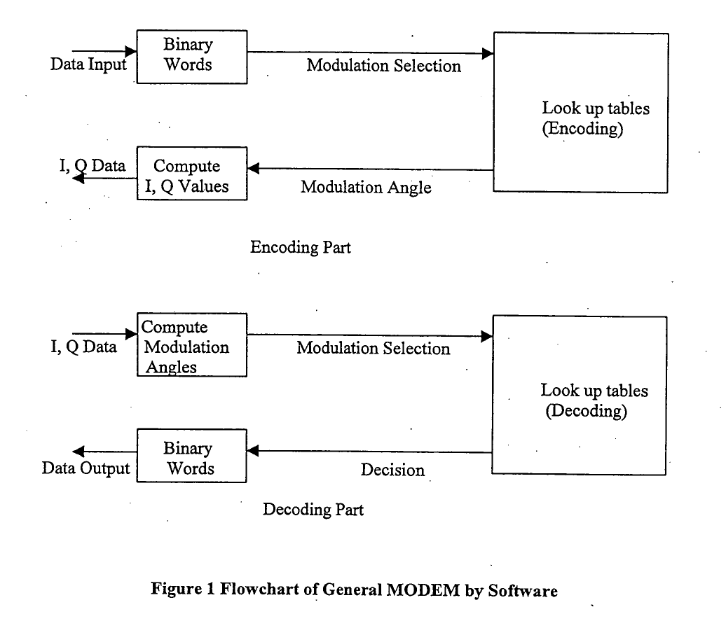

FIG. 1 illustrates, in the form of a flow diagram, a general modem for both MPSK and MDPSK modulation schemes according to an embodiment of the invention.

In the encoding part of FIG. 1, the data input is converted into binary words and the type of modulation is selected. The binary words are then converted in an encoding look-up table for the selected modulation scheme to give a modulation angle corresponding to the data input. Using this modulation angle, the in-phase and quadrature values of the modulated data are calculated for transmission.

In the decoding part of FIG. 1, the incoming in-phase I and quadrature Q data is used to compute the modulation angle and the type of modulation scheme used is determined. The calculation of the in-phase I and quadrature Q values and the modulation angles is described in more detail below. From the decoding look-up tables, a decision is made as to the binary words corresponding to the modulation angles received and these binary words are converted to recover the data originally encoded and to provide a data output signal.

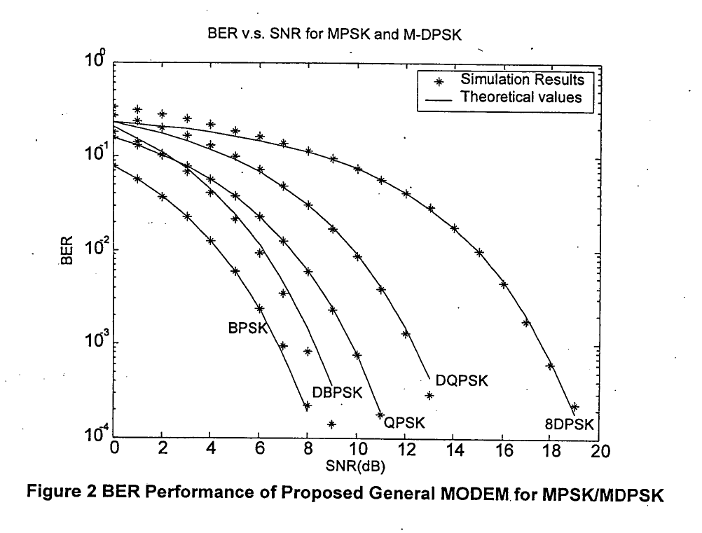

A system such as that shown in FIG. 1 and described above has been simulated and the results compared with theoretical calculated values for the MPSK and MDPSK modulation schemes. FIG. 2 shows the results of these calculations and simulations for the proposed general MODEM illustrated in FIG. 1 for MPSK and MDPSK modulation schemes.

In FIG. 2, the BER is plotted against signal-to-noise ratio (SNR) for each of the systems considered.

It should be noted that QPSK-CCK and QPSK-OFDM have similar BER performance, and DQPSK-DSSS, DQPSK-CCK and pi/4 DQPSK have similar BER performance.

It will be seen from FIG. 2 that the performance is in line with the theoretical values under AWGN channels.

In the first preferred embodiment described above, the general modem is preferably implemented using software.

In a further preferred embodiment, which is a variation of the first embodiment, both the computation (that is, the calculation of the modulation angles, and the calculation of the in-phase I and quadrature Q values) and the look-up tables may be implemented in hardware, leaving only the control portion to be performed in the software domain. This will increase the speed of operation of the system.

The performance of the second embodiment is similar to that of the first embodiment and therefore the results shown in FIG. 2 are applicable to the second embodiment.

In a further preferred embodiment, the control function and the computation functions such as the calculation of the modulation angles by the decoding system and the calculation of the in-phase I and quadrature Q values in the encoding system, may be implemented by software and the look-up tables may be implemented in hardware. This may reduce the memory requirement of the system.

Determination of I and Q Values

In MPSK schemes, the determination of the I and Q values may comprise the calculation of trigonometric functions. As the number of possible I and Q values is very limited in such schemes, the determination of these values may be performed using look-up tables. Table 11 shows possible I and Q values for use in the general modem of FIG. 1 for a Bluetooth/WLAN/PHS system.

TABLE 11
Look up table for I, Q Values for MPSK

| Modulation Angles | I, Q Values |
|---|---|
| 0 | (1, 0) |
| Pi/4 | (0.707, 0.707) |
| Pi/2 | (0, 1) |
| 3*Pi/4 | (−0.707, 0.707) |
| Pi | (−1, 0) |
| −3*Pi/4 | (−0.707, −0.707) |
| −Pi/2 | (0, −1) |
| −Pi/4 | (0.707, −0.707) |

For MDPSK schemes, a further step is required for the determination of the I and Q values compared with that of MPSK, namely, the I and Q values obtained from Table 11 are multiplied by the previous modulated information bit. Alternatively, the modulation angle of the previous modulated information bit may be stored and added to the phase shift decided by the information bit currently being processed and the encoding rules of the modulation scheme currently in use. The I and Q values of information bit currently being processed may then be obtained from Table 11.

Computation of Modulation Angles

Preferably, the computation of modulation angles may be achieved by calculating the inverse tangent of the I and Q values currently being processed, which constitutes the input modulated complex symbol.

MPSK and MDPSK are widely used in wireless communication systems and preferred embodiments of the invention may assist in the reduction of the implementation cost and enhance the flexibility of, for example, multi-mode wireless communications terminals, base stations and access points which use such modulation schemes.

Various modifications to the embodiments of the present invention described above may be made. For example, other modules and method steps can be added or substituted for those above. Thus, although the invention has been described above using particular embodiments, many variations are possible within the scope of the claims, as will be clear to the skilled reader, without departing from the spirit and scope of the invention.

1. A modulation/demodulation apparatus for the encoding and decoding of data, said apparatus comprising:
an encoding system to encode incoming data according to a first plurality of modulation schemes; and
a decoding system to decode according to said first plurality of modulation schemes said encoded data received from said encoding system;
wherein the encoding system comprises one or more encoding look-up tables, said one or more encoding look-up tables comprising encoding data for encoding said incoming data according to said first plurality of modulation schemes, wherein said encoding data for a number of said first plurality of modulation schemes is identical; and
wherein the decoding system comprises one or more decoding look-up tables for decoding said encoded data received from said encoding system, said one or more decoding look-up tables comprising decoding data for decoding data according to said first plurality of modulation schemes, wherein said decoding data for a number of said first plurality of modulation schemes is identical.

2. The modulation/demodulation apparatus of claim 1, wherein said encoding system comprises:
a converter for converting incoming data to one or more binary words, said binary words being formed of one or more information bits; and
a selector for selecting a type of modulation to be applied to said one or more binary words; wherein said one or more encoding look-up tables are arranged for determining one or more modulation angles corresponding to said one or more information bits according to said selected type of modulation; said encoding system further comprising a first processor for determining an in-phase value and a quadrature value for said one or more modulation angles for transmission to said decoding system.

3. The modulation/demodulation apparatus of claim 2, wherein said decoding system comprises:
a second processor for determining said one or more modulation angles from said in-phase and quadrature values received from said encoding system; and
a selector for determining the type of modulation applied to said encoded signal; wherein said one or more decoding look-up tables are arranged to determine said one or more binary words formed by said encoding system, said decoding system further comprising a converter for converting said one or more binary words into a data output signal.

4. The modulation/demodulation apparatus of claim 2, wherein said encoding data is comprised of data from mapping tables associated with said plurality of modulation schemes.

5. The modulation/demodulation apparatus of claim 4, wherein said data from said mapping tables comprises a combination of data from similar modulation schemes so that similar modulation schemes use the same encoding data.

6. The modulation/demodulation apparatus of claim 3, wherein said decoding data is comprised of data from mapping tables associated with said plurality of modulation schemes.

7. The modulation/demodulation apparatus of claim 6, wherein said data from said mapping tables comprises a combination of data from similar modulation schemes so that similar modulation schemes use the same decoding data.

8. The modulation/demodulation apparatus of claim 1, wherein said plurality of modulation schemes comprises multi-array phase shift keying (MPSK) and multi-array differential phase shift keying (MDPSK).

9. The modulation/demodulation apparatus of claim 1, wherein said plurality of modulation schemes comprises a combination of any two or more of BPSK, QPSK, QPSK-CCK, DBPSK,DQPSK, DQPSK-CCK,pi/4-DQPSK, and 8DPSK.

10. The modulation/demodulation apparatus of claim 2, wherein said first processor is arranged to determine said in-phase and quadrature values using trigonometric functions.

11. The modulation/demodulation apparatus of any claim 2, wherein said first processor is arranged to determine said in-phase and quadrature values using a look-up table.

12. The modulation/demodulation apparatus of claim 10, wherein said first processor is arranged to determine said in-phase and quadrature values using a look-up table.

13. The modulation/demodulation apparatus of claim 3, wherein said second processor is arranged to determine said one or more modulation angles from said in-phase and quadrature values by calculating the inverse tangent of the angle represented by said in-phase and quadrature values.

14. A Bluetooth system comprising the modulation/demodulation apparatus of claim 1.

15. A WLAN system comprising the modulation/demodulation apparatus of claim 1.

16. A cellular network system comprising the modulation/demodulation apparatus of claim 1.

17. A multi-mode system based on a software defined radio system comprising the modulation/demodulation apparatus of claim 1.

18. A method for encoding and decoding data, said method comprising:
encoding data according to a first plurality of modulation schemes; and
decoding according to said first plurality of modulation schemes said encoded data;
wherein the step of encoding data comprises applying identical encoding data from one or more encoding look-up tables to data to be encoded according to a number of said first plurality of modulation schemes; and
wherein the step of decoding data comprises applying identical decoding data from one or more decoding look-up tables to data to be decoded according to a number of said first plurality of modulation schemes.

19. The method of claim 18, wherein the step of encoding comprises, in an encoding system, the steps of:
converting incoming data to one or more binary words, said binary words being formed of one or more information bits;
selecting a type of modulation to be applied to said one or more binary words;
determining using said one or more encoding look-up tables one or more modulation angles corresponding to said one or more information bits according to said selected type of modulation; and
determining an in-phase value and a quadrature value for each of a number of said one or more modulation angles for transmission to a decoding system.

20. The method of claim 18, wherein the step of decoding comprises:
determining said one or more modulation angles from said in-phase and quadrature values received from said encoding system;
determining the type of modulation applied to said encoded signal;
determining using said one or more decoding look-up tables said one or more binary words formed by said encoding system; and
converting said one or more binary words into a data output signal.

21. The method of claim 18, wherein the step of applying identical encoding data comprises applying data from mapping tables associated with said plurality of modulation schemes.

22. The method of claim 21, wherein the step of applying data from mapping tables comprises applying a combination of data from similar modulation schemes so that similar modulation schemes use the same encoding data.

23. The method of claim 18, wherein the step of applying identical decoding data comprises applying data from mapping tables associated with said plurality of modulation schemes.

24. The method of claim 23, wherein the step of applying data from mapping tables comprises applying a combination of data from similar modulation schemes so that similar modulation schemes use the same decoding data.

25. The method of claim 18, wherein the step of encoding comprises encoding said data according to multi-array phase shift keying (MPSK) and multi-array differential phase shift keying (MDPSK) modulation schemes.

26. The method of claim 18, wherein the step of encoding comprises encoding said data according to a combination of any two or more of BPSK, QPSK, QPSK-CCK, DBPSK,DQPSK, DQPSK-CCK,pi/4-DQPSK, and 8DPSK modulation schemes.

27. The method of claim 19, wherein the step of determining said in-phase and quadrature values comprises determining said values using trigonometric functions.

28. The method of claim 19, wherein the step of determining said in-phase and quadrature values comprises determining said values using a look-up table.

29. The method of claim 27, wherein the step of determining said in-phase and quadrature values comprises determining said values using a look-up table.

30. The method of claim 20, wherein the step of determining said one or more modulation angles from said in-phase and quadrature values comprises calculating the inverse tangent of the angle represented by said in-phase and quadrature values.

31. A method of encoding and decoding data in a Bluetooth system comprising the method of claim 18.

32. A method of encoding and decoding data in a WLAN system comprising the method of claim 18.

33. A method of encoding and decoding data in a cellular network system comprising the method of claim 18.

34. A method of encoding and decoding data in a multi-mode system based on a software defined radio system comprising the method of claim 18.
